(19) United States
(12) Patent Application Publication
(10) Pub. No.: US 2010/0059508 A1
(43) Pub. Date: Mar. 11, 2010

(54) SEMICONDUCTOR PROCESSING

(75) Inventor: Bohumil Lojek, Colorado Springs, CO (US)

Correspondence Address: FISH & RICHARDSON P.C., PO BOX 1022, MINNEAPOLIS, MN, 55440-1022, US

(73) Assignee: ATMEL CORPORATION, San Jose, CA (US)

(21) Appl. No.: 12/205,175

(22) Filed: Sep. 5, 2008

(51) Int. Cl. H05B 6/70; H05B 6/80

(52) U.S. Cl. 219/690; 219/695; 219/710; 219/745; 219/750

(57) ABSTRACT

This document discloses semiconductor processing systems, methods, and devices. The systems, methods and devices activate dopants in a processing chamber having a temperature that is less than, for example, 300 degrees. A microwave energy source provides a microwave transmission to a waveguide system that uniformly distributes the microwave transmission. The waveguide system can include a rectangular waveguide coupled to a cylindrical waveguide. The rectangular waveguide guides the microwave transmission in a second propagation direction to a cylindrical waveguide. The cylindrical waveguide uniformly distributes the electromagnetic transmission and guides the electromagnetic transmission in a third propagation direction to a processing chamber. A semiconductor wafer can be exposed to the microwave transmission and the temperature of the chamber to activate dopants in the semiconductor wafer.

### BACKGROUND

This specification relates to semiconductor processing.

Electronic devices are being developed that offer more performance while utilizing less power and in smaller packages. For example, portable computing devices have evolved into comprehensive data devices that integrate the features of phones, personal data assistants and computers. As the capabilities of these devices increase, so do their memory requirements. The increasing memory requirements of electronic devices coupled with shrinking packaging dimensions requires more transistors to be formed on a semiconductor wafer. Therefore, transistor device scaling can be used to provide more transistors in a smaller package.

One way to scale transistor devices is to reduce the area of the semiconductor substrate in which terminals are defined. For example, areas that define sources and drains of field effect transistors can be reduced to achieve device scaling. However, in some situations, the size of these terminals can be limited by lateral diffusion of dopants used to define the terminals. Accordingly, in some semiconductor devices, dopant lateral diffusion can limit device scaling.

### SUMMARY

Various aspects of semiconductor processing systems, methods, and devices are disclosed. The systems, methods and devices can activate dopants in a processing chamber having a temperature that is less than about 300 degrees. A microwave energy source provides a microwave transmission to a waveguide system that distributes the microwave transmission. The waveguide system can include a rectangular waveguide coupled to a cylindrical waveguide. The rectangular waveguide guides the microwave transmission in a second propagation direction to a cylindrical waveguide. The cylindrical waveguide uniformly distributes the electromagnetic transmission and guides the electromagnetic transmission in a third propagation direction to a processing chamber. A semiconductor wafer can be exposed to the microwave transmission and the temperature of the chamber to activate dopants in the semiconductor wafer.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example semiconductor processing system.

FIG. 2 is a flow chart of an example process of annealing a semiconductor substrate.

FIG. 3 is a flow chart of an example process of generating an electromagnetic energy having an electric field that is substantially uniform.

Like reference numbers and designations in the various drawings indicate like elements.

### DETAILED DESCRIPTION

### §1.0 Semiconductor Processing

This document discloses semiconductor processing systems, devices and methods. A semiconductor processing system can be used, for example, to activate (e.g., anneal) dopants that are implanted in a semiconductor substrate to define sources and drains of a semiconductor device (e.g., memory cell). Dopants can be activated, for example, by exposing the semiconductor substrate to elevated chamber temperatures (e.g., greater than 900 degrees Celsius). However, elevated temperatures can cause lateral diffusion of the dopants through the semiconductor substrate. In some semiconductor devices, this lateral diffusion can limit device scaling.

For example, some transistor devices (e.g., field effect transistors) require that a minimum channel length (e.g., length between the source and the drain) be maintained between the terminals (e.g., source and drain) for proper operation of the device. Thus, a reduction in the channel length due to lateral diffusion of the terminals can limit device scaling because the terminals may be spaced further apart to compensate for the lateral diffusion resulting from the elevated temperatures.

Dopants can also be activated at lower temperatures by exposing the semiconductor substrate to an electromagnetic energy source. The electromagnetic energy can be absorbed by the semiconductor substrate and can cause excitation of the crystal lattice. This excitation of the crystal lattice can generate heat within the semiconductor substrate. The heat generated by the crystal lattice excitation and interaction of electromagnetic energy with dopants can facilitate activation of the dopants at lower temperatures than otherwise required because additional energy is being provided by the interaction of the electromagnetic energy and the semiconductor substrate.

If the electromagnetic energy is not absorbed uniformly throughout the semiconductor substrate, some portions of the semiconductor substrate may absorb less electromagnetic energy than other portions. In turn, these portions of the semiconductor wafer that absorb less electromagnetic energy can require higher temperatures to activate the dopants. Thus, in these situations the lateral diffusion caused by the higher temperatures may still limit device scaling.

The uniformity of the energy absorbed by the semiconductor substrate can be increased by increasing the uniformity of the distribution of electromagnetic transmission paths that enter the processing chamber. Additionally, the energy absorbed by the semiconductor substrate can be increased by increasing the magnitude of the transmission path vectors that are perpendicular to the semiconductor substrate so that a higher percentage of the electromagnetic transmission is absorbed by the semiconductor substrate.

In some implementations, a semiconductor processing system can be implemented with a cylindrical waveguide that increases the uniformity of the electromagnetic transmission path distribution and adjusts the angle of the transmission paths to be more perpendicular to the semiconductor wafer. This document discusses cylindrical waveguides and rectangular waveguides for example, purposes. However, other waveguide shapes can be used.

### §2.0 Example Semiconductor Processing System

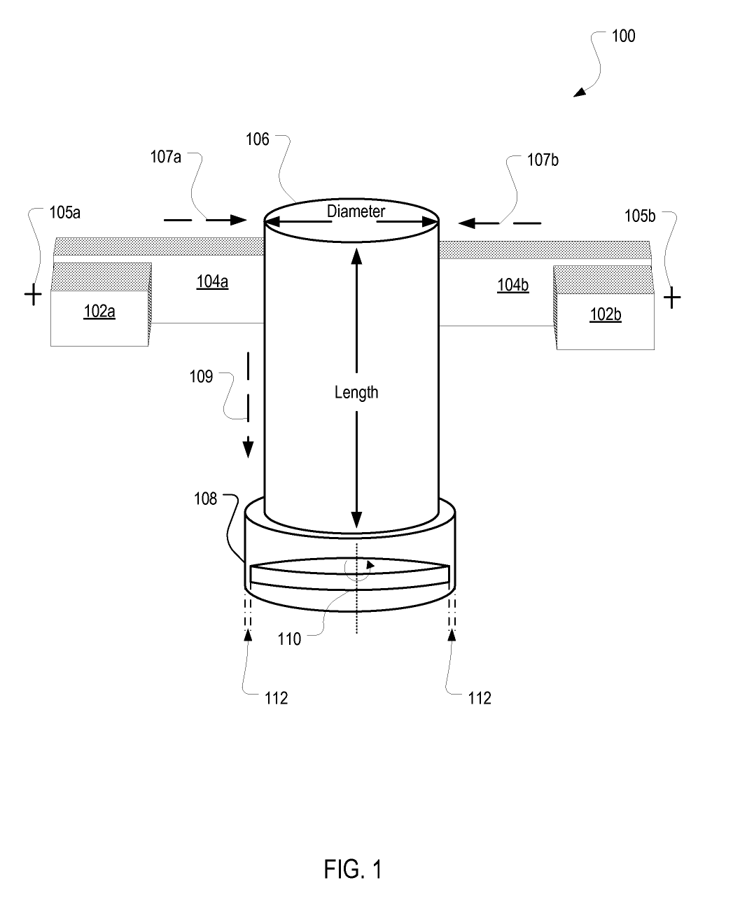

FIG. 1 is a block diagram of an example semiconductor processing system 100. The processing system 100 can increase the uniformity of the electromagnetic transmission distribution and direct the electromagnetic energy in a propagation direction that is perpendicular to a semiconductor substrate to be processed by the system 100. The substantially uniform electromagnetic transmission can be used to activate dopants at chamber temperatures that are less than a predefined temperature (e.g., 300 degrees Celsius). The predefined temperature can be based, for example, on a dopant diffusion tolerance for a scaled device. The semiconductor processing system 100 can include an electromagnetic energy sources 102a, 102b, rectangular waveguides 104a, 104b, a cylindrical waveguide 106 and a processing chamber 108.

One or more waveguides define a waveguide system. For example, rectangular waveguide 104a and cylindrical waveguide 106 can define a waveguide system. Similarly, rectangular waveguide 104a, rectangular waveguide 104b and cylindrical waveguide 106 can define a waveguide system. The processing system 100 is presented two electromagnetic energy sources 102a, 102b and a waveguide system defined by two rectangular waveguides 104a, 104b and one cylindrical waveguide to simplify the discussion. However, more electromagnetic energy sources, rectangular waveguides and cylindrical waveguides can be used based on the application.

In some implementations, the electromagnetic energy sources 102a, 102b can generate C-band (e.g., 4-8 GHz) microwave transmissions. The transmissions generated by the electromagnetic energy sources 102a, 102b will have wavelengths that correspond to the transmission frequency. For example, a 5 GHz transmission will have a corresponding wavelength of ˜6 cm. Each microwave transmission can propagate in a first propagation direction that can be defined by the orientation of an output of the electromagnetic energy sources 102a, 102b. The discussion of the processing system 100 will focus on electromagnetic energy source 102a and rectangular waveguide 104a to simplify the explanation.

The electromagnetic energy sources 102a, 102b can be coupled to respective rectangular waveguides 104a, 104b so that an output of the energy sources 102a, 102b is coupled to an input of the rectangular waveguide 104a, 104b, respectively. The inputs of the rectangular waveguides 104a, 104b can be defined in one of the sides near first ends of the rectangular waveguides 104a, 104b, respectively. The rectangular waveguides 104a, 104b can have outputs defined in respective second ends. The rectangular waveguides 104a, 104b can be constructed of brass, copper, silver, aluminum or any other appropriate metal that has a low bulk resistivity.

The rectangular waveguides 104a, 104b can receive the microwave transmissions from the electromagnetic energy sources 102a, 102b (e.g., magnetrons) at the respective inputs and guide the transmissions to the outputs of the rectangular waveguides 104a, 104b. In some implementations, the propagation directions of the microwave transmission at the input of the rectangular waveguides 104a, 104b can be perpendicular to the propagation directions of the microwave transmissions at the outputs of the rectangular waveguides 104a, 104b. For example, if the electromagnetic energy sources 102a, 102b generate electromagnetic transmissions that have propagation directions 105a, 105b that are perpendicular into the plane of the paper, as denoted by (+), then the electromagnetic transmissions can have propagation directions 107a, 107b at the respective outputs of the rectangular waveguides 104a, 104b. As shown in FIG. 1, the propagation directions 105a, 105b are perpendicular to the propagation directions 107a, 107b, respectively.

The energy distribution of the microwave transmissions can be non-uniform as the transmissions propagate through the rectangular waveguides 104a, 104b. For example, the microwave transmissions can have an energy distributions that are concentrated in particular portions of the rectangular waveguides 104a, 104b (e.g., at locations that correspond to peaks of sine or half-sine field distributions).

The non-uniformity of the microwave transmissions can cause “hot spots” and “cool spots” in a semiconductor wafer that is exposed to the microwave transmissions. The “hot spots” correspond to portions of the semiconductor wafer that are exposed to high energy portions of the microwave transmissions and, therefore, heat more rapidly than portions of the semiconductor wafer that is exposed to lower energy portions of the microwave transmissions. Accordingly, the “cool spots” correspond to the portions of the semiconductor wafer that are exposed to the lower energy portions of the microwave transmissions because these portions will not heat as rapidly as the “hot spots.”

Dopants that are located in the “cool spots” of the semiconductor wafer may activate at a higher temperature than dopants located in the “hot spots.” Thus, to ensure that all of the dopants in the semiconductor wafer are activated, the chamber can be heated to a temperature that can activate the dopants in the “cool spots.” This temperature will be higher than the temperature required to activate the dopants in the “hot spots.” The increased temperature required to activate the dopants in the “cool spots” can increase the lateral diffusion of the dopants and, in turn, limit device scaling.

In some implementations, the energy of the microwave transmissions that enter the chamber 108 can be more uniformly distributed. Uniformly distributing the energy of the microwave transmissions results in relatively uniform temperatures throughout the semiconductor wafer 110. When the semiconductor wafer 110 is exposed to uniformly distributed microwave energy, each portion of the semiconductor wafer 110 can have a wafer temperature that exceeds the temperature of the “cool spots.” Thus, the temperature required to activate all of the dopants can be lowered, in turn, lowering the lateral diffusion of the dopants and increasing device scaling.

In some implementations, a more uniform energy distribution can be achieved by connecting the outputs of the rectangular waveguides 104a, 104b to a cylindrical waveguide 106. The cylindrical waveguide 106 can have a first end, a second end and a first circumferential wall. The cylindrical waveguide 106 can have inputs defined in the first circumferential wall near the first end, and an output defined in the second end. The inputs of the cylindrical waveguide 106 can be connected to the outputs of the rectangular waveguides 104a, 104b. The output of the cylindrical waveguide 106 can be connected to the processing chamber 108. The cylindrical waveguide 106 can be constructed of brass, copper, silver, aluminum or any other appropriate metal that has a low bulk resistivity.

As discussed, the cylindrical waveguide 106 can have multiple inputs defined in the first circumferential wall. Each input can be connected to an output of a separate rectangular waveguide 104. Additional rectangular waveguides 104 can be used, for example, when a higher energy is required to anneal semiconductor wafers. When multiple rectangular waveguides 104 are connected to the cylindrical waveguide 106, the rectangular waveguides 104 can be evenly spaced around the circumference of the cylindrical waveguide 106.

The cylindrical waveguide 106 can receive the microwave transmissions from the outputs of the rectangular waveguides 104a, 104b and guide the microwave transmissions toward the output of the cylindrical waveguide 106. In some implementations, the propagation direction of the microwave transmissions received from the outputs of the rectangular waveguides 104a, 104b (e.g., second propagation direction) can be perpendicular to the propagation direction of the microwave transmissions at the output of the cylindrical waveguide 106 (e.g., third propagation direction). For example, if the microwave transmissions have propagation directions 107a, 107b at the output of the rectangular waveguides 104a, 104b, then the microwave transmissions can have a common propagation direction 109 at the output of the cylindrical waveguide 106.

In some implementations, the cylindrical waveguide 106 can have a length and a diameter that facilitates a more uniform energy distribution as the microwave transmissions propagate through the cylindrical waveguide 106. In some implementations, the cylindrical waveguide 106 has a diameter that is at least twice the wavelength of the microwave transmission and a length that is one-half of the wavelength. For example, as discussed above a 5 GHz microwave transmission has a wavelength of ˜6 cm. Therefore, the diameter of the cylindrical waveguide 106 that is used in the semiconductor processing system 100 can have a diameter that is at least 12 cm (e.g., 6 cm*2) and a length that is 3 cm (e.g., 6 cm/2). A cylindrical waveguide 106 having these dimensions can provide a 5 GHz microwave transmission output that is uniformly distributed and propagates toward the processing chamber 108 (e.g., vertically in FIG. 1).

For example, the outputs of the rectangular waveguides 104a, 104b can be 5 GHz transmissions having energy distributions with a dominant mode. The cylindrical waveguide 106 having a diameter of 12 cm and a length of 3 cm can receive these dominant mode transmissions from the rectangular waveguides 104a, 104b. As the 5 GHz transmissions propagate through the cylindrical waveguide 106, the dominant mode will be reduced and the 5 GHz transmission will have a multimode transmission pattern as the 5 GHz transmission enters the processing chamber 108.

The processing chamber 108 can be a chamber that receives a semiconductor wafer 110 for processing. In some implementations, the semiconductor wafer 110 can be received on a quartz mounting surface in the processing chamber 108. The processing chamber 108 can be, for example, a steel multimode chamber. Using a multimode chamber facilitates distribution of the microwave transmission over a large area of the processing chamber 108 because the multiple transmission modes that are received from the cylindrical waveguide can more effectively distribute the energy of the microwave transmission than a single mode. Therefore, the chamber 108 can be constructed to receive a larger semiconductor wafer 110 (e.g., 8 inch diameter) than can be processed in a single mode chamber.

In some implementations, the processing chamber 108 can have a cylindrical shape. A cylindrical processing chamber 108 can have a second circumferential wall and two ends. In some implementations, the cylindrical waveguide 106 can be connected to an end of the processing chamber 108. Connecting the cylindrical waveguide 106 to the end of the processing chamber 108 causes the microwave transmission to enter the processing chamber 108 in a direction that is substantially parallel to the walls of the processing chamber 108. Therefore, a semiconductor wafer 110 can be situated in the processing chamber 108 so that the surface of the semiconductor wafer 110 to be processed is substantially perpendicular to the microwave transmission. Situating the surface of the semiconductor wafer 110 perpendicular to the microwave transmission can result in absorption of a higher percentage of the microwave transmission by the semiconductor wafer 110.

In some implementations, the magnitude of the microwave transmission that is absorbed by the surface of the semiconductor wafer 110 can be increased by reducing the size of the processing chamber 108. For example, a semiconductor wafer 110 can be processed in a processing chamber 108 having an inner-wall that minimizes a space 112 between the edge of the semiconductor wafer 110 and the inner-wall of the processing chamber 108. Reducing the space 112 between the edge of the semiconductor wafer 110 and the inner-wall of the processing chamber 108 can increase the amount of microwave transmission energy that is incident on the surface of the semiconductor wafer 110 as discussed below.

Microwave transmissions that enter the processing chamber 108 can travel on paths that are located between the semiconductor wafer 110 and the inner-wall of the processing chamber 108. The microwave transmissions that travel on these paths will not initially come into contact with the semiconductor wafer 110. Therefore, these microwave transmissions can continue traveling on their respective paths until the microwave transmissions come into contact with the inner-walls of the processing chamber 108. In some situations, the microwave transmissions can reflect off the walls of the processing chamber 108 and potentially be absorbed by the semiconductor wafer 110. However, these microwave transmissions can also reflect back into the cylindrical waveguide 106, in turn, reducing the magnitude of the energy entering the processing chamber 108 or damaging the energy sources 102a, 102b.

Reducing the size of the processing chamber 108 can reduce the microwave transmissions that travel on paths between the semiconductor wafer 110 and the inner-wall of the processing chamber 108. Therefore, a larger percentage of the microwave transmissions will be incident on the semiconductor wafer 110 upon entry into the processing chamber 108. Similarly, a larger percentage of the microwave transmissions that travel on paths between the semiconductor wafer 110 and the inner-wall of the processing chamber 108 will be absorbed after reflecting off the inner-wall of the processing chamber 108. Thus, a smaller portion of the microwave transmission will reflect back into the cylindrical waveguide 106.

In some implementations, reflections into the cylindrical waveguide 106 can be further reduced by coating the inner-wall of the processing chamber 108 with an anti-reflective material. For example, the inner-wall of the processing chamber 108 can be coated with iridium or a chromate coating (e.g., hexavalent-chromium). The anti-reflective coating can limit reflection of the microwave transmission from the walls of the processing chamber 108 and, in turn, the amount of energy that is reflected into the cylindrical waveguide 106. Because less energy is reflected back into the cylindrical waveguide 106, a higher percentage of the microwave transmission energy output from the cylindrical waveguide 106 can enter the processing chamber 108. Thus, more energy is available in the processing chamber 108 to activate dopants in the semiconductor wafer 110. In some implementations, the increased energy available in the processing chamber 108 can facilitate dopant activation at temperatures less than 300 degrees Celsius.

### §3.0 Example Process Flow

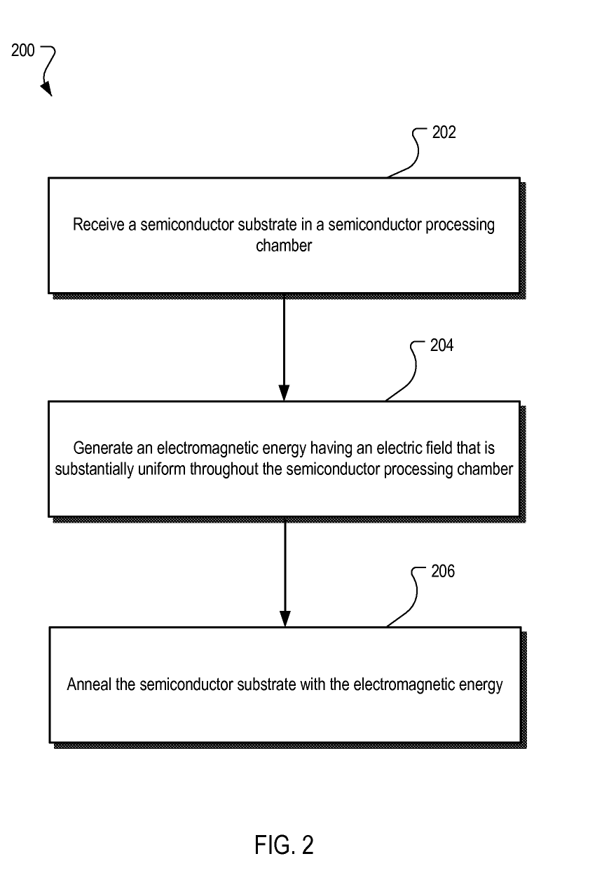

FIG. 2 is a flow chart of an example process 200 of annealing a semiconductor substrate. The process 200 can be implemented, for example, in the semiconductor processing system 100.

Stage 202 receives a semiconductor substrate in a semiconductor processing chamber (e.g., processing chamber 108). The semiconductor substrate (e.g. semiconductor substrate 110 of FIG. 1) can be silicon, silicon germanium, gallium arsenide, or any other appropriate semiconductor material. The semiconductor substrate can have device areas defined by dopants. For example, dopants can be implanted in the semiconductor substrate to define sources and drains of semiconductor devices (e.g., transistors). The sources and drains can be defined by dopants that are activated by elevated temperatures (e.g. annealing). The semiconductor substrate can be received, for example, by the processing chamber 108.

Stage 204 generates an electromagnetic energy and an electric field that is substantially uniform throughout the semiconductor processing chamber. In some implementations, the substantially uniform electromagnetic energy can be generated by distributing electromagnetic transmissions to form a multimode transmission. For example, a waveguide system including a cylindrical waveguide (e.g., cylindrical waveguide 106 of FIG. 1) can be used to convert dominant mode transmissions into multimode transmissions. The electromagnetic energy can be generated, for example, by the processing system 100.

Stage 206 anneals the semiconductor substrate with the electromagnetic energy. In some implementations, the semiconductor substrate (e.g., semiconductor substrate 110 of FIG. 1) can be annealed by introducing the electromagnetic energy into an end of a cylindrical processing chamber (e.g., processing chamber 108 of FIG. 1). In some implementations, the cylindrical processing chamber can have a temperature that is less than a predefined temperature (e.g., 300 degrees Celsius). The predefined temperature can be based, for example, on a dopant diffusion tolerance for a scaled device. The semiconductor substrate can be annealed, for example, in the processing chamber 108.

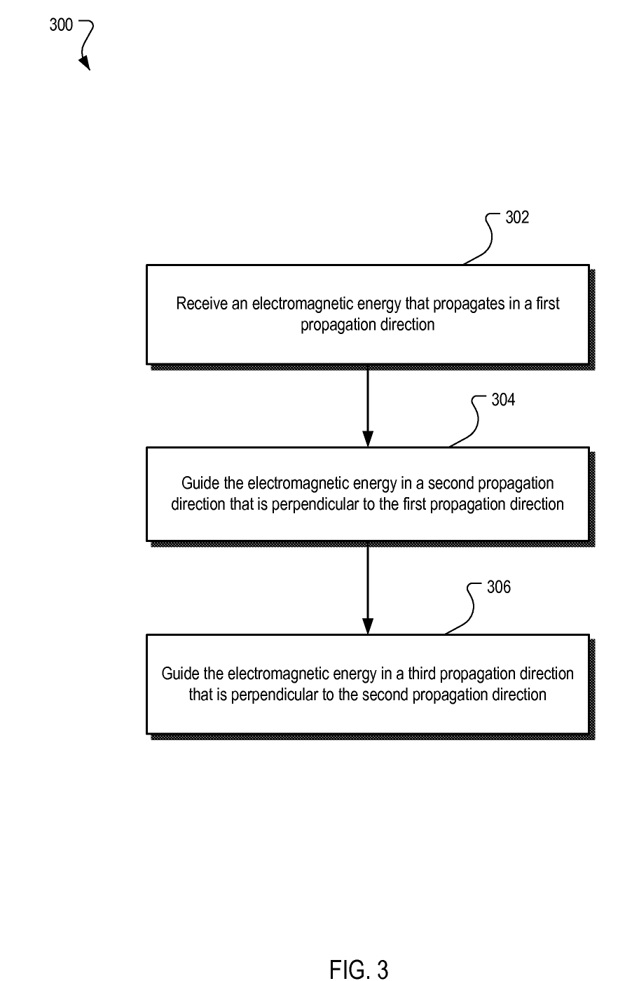

FIG. 3 is a flow chart of an example process 300 of generating an electromagnetic energy having an electric field that is substantially uniform. The process 300 can be implemented, for example, in the semiconductor processing system 100.

Stage 302 receives an electromagnetic energy that propagates in a first propagation direction (e.g., propagation direction 105a of FIG. 1). In some implementations, the electromagnetic energy can be a C-band microwave transmission that is received from a microwave source (e.g., electromagnetic energy source 102a of FIG. 1). The electromagnetic energy can be received, for example, by the rectangular waveguide 104.

Stage 304 guides the electromagnetic energy in a second propagation direction that is perpendicular to the first propagation direction. In some implementations, the electromagnetic energy can have a non-uniform energy distribution as the electromagnetic energy propagates in the second propagation direction (e.g., propagation direction 107a of FIG. 1). For example, electromagnetic energy can be concentrated in particular portions of a rectangular waveguide (e.g., rectangular waveguide 104a of FIG. 1) through which the energy is propagating. The electromagnetic energy can be guided in the second propagation direction, for example, by the rectangular waveguide 104.

Stage 306 guides the electromagnetic energy in a third propagation direction that is perpendicular to the second propagation direction. In some implementations, the electromagnetic energy can have a substantially uniform energy distribution as the electromagnetic energy propagates in the third propagation direction (e.g., propagation direction 109 of FIG. 1). The third propagation direction can be perpendicular to a surface of the semiconductor substrate (e.g., semiconductor substrate 110 of FIG. 1). The electromagnetic energy can be guided in the third propagation direction, for example, by the cylindrical waveguide 106.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while process steps are depicted in the drawings in a particular order, this should not be understood as requiring that such process steps be performed in the particular order shown or in sequential order, or that all illustrated process steps be performed, to achieve desirable results.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A system, comprising:
a semiconductor processing chamber to receive a semiconductor substrate for processing, the semiconductor processing chamber including a top and a bottom; and
a waveguide system coupled to the top or the bottom of the semiconductor processing chamber, the waveguide system having a structure that distributes an electromagnetic energy in the semiconductor processing chamber such that dopants in the semiconductor substrate are activated at a temperature that is less than a predefined temperature.

2. The method of claim 1, wherein the predefined temperature is about 300 degrees Celsius.

3. The system of claim 1, wherein the waveguide system comprises:
a rectangular waveguide that receives an electromagnetic energy propagating in a first propagation direction and directs the electromagnetic energy in a second propagation direction that is substantially perpendicular to the first propagation direction; and
a cylindrical waveguide including a first end, a second end, and a first circumferential wall, the first circumferential wall at the first end coupled to the rectangular waveguide to direct the electromagnetic energy in a third propagation direction that is substantially perpendicular to the second propagation direction, the second end of the rectangular waveguide coupled to the semiconductor processing chamber to provide the electromagnetic energy to the semiconductor processing chamber.

4. The system of claim 3, wherein the cylindrical waveguide has a diameter defined by a wavelength of the electromagnetic energy.

5. The system of claim 3, wherein the cylindrical waveguide has a length defined by a wavelength of the electromagnetic energy.

6. The system of claim 1, wherein the electromagnetic energy is a C-band microwave transmission.

7. The system of claim 1, wherein the semiconductor processing chamber has an inner-wall that is anti-reflective.

8. The system of claim 7, wherein the inner-wall comprises a chromate coating.

9. The system of claim 7, wherein the inner-wall comprises hexavalent-chromium.

10. The system of claim 3, further comprising an electromagnetic energy source coupled to the rectangular waveguide.

11. The system of claim 10, wherein the electromagnetic energy source comprises a magnetron.

12. The system of claim 1, wherein the semiconductor processing chamber includes a quartz mounting surface to receive the semiconductor substrate for processing.

13. A method, comprising:
receiving a semiconductor substrate in a semiconductor processing chamber;
generating an electromagnetic energy and an electric field that is substantially uniform throughout the semiconductor processing chamber; and
annealing the semiconductor substrate with the electromagnetic energy.

14. The method of claim 13, wherein generating the electromagnetic energy comprises:
receiving a non-uniform electromagnetic energy that propagates in a first propagation direction;
guiding the non-uniform electromagnetic energy to propagate in a second propagation direction that is perpendicular to the first propagation direction, the electromagnetic energy having a non-uniform energy distribution as the electromagnetic energy propagates in the second propagation direction; and
guiding the electromagnetic energy to propagate in a third propagation direction that is substantially perpendicular to the second propagation direction, the electromagnetic energy having a uniform energy distribution as the electromagnetic energy propagates in the third propagation direction, the third propagation direction being substantially perpendicular to a surface of the semiconductor substrate.

15. The method of claim 14, wherein the electromagnetic energy comprises a C-band microwave transmission.

16. The method of claim 13, wherein the annealing is performed at a temperature less than about 300 degrees Celsius.

17. The method of claim 14, wherein the electromagnetic energy is redirected in a second propagation direction by a rectangular waveguide.

18. The method of claim 14, wherein the electromagnetic energy is redirected in a third propagation direction by a cylindrical waveguide.

19. The method of claim 18, wherein a diameter of the cylindrical waveguide is at defined by a wavelength of the electromagnetic energy.

20. The method of claim 19, wherein a length of the cylindrical waveguide is defined by a wavelength of the electromagnetic energy.

21. The method of claim 14, wherein annealing the semiconductor substrate comprises introducing the electromagnetic energy to the semiconductor processing chamber at a first end or a second end of the processing chamber.

22. A method of generating electromagnetic energy comprising:
receiving a non-uniform electromagnetic energy that propagates in a first propagation direction;
guiding the non-uniform electromagnetic energy to propagate in a second propagation direction that is perpendicular to the first propagation direction, the electromagnetic energy having a non-uniform energy distribution as the electromagnetic energy propagates in the second propagation direction; and
guiding the electromagnetic energy to propagate in a third propagation direction that is substantially perpendicular to the second propagation direction, the electromagnetic energy having a substantially uniform energy distribution as the electromagnetic energy propagates in the third propagation direction, the third propagation direction being substantially perpendicular to a surface of the semiconductor substrate.

23. The method of claim 22, wherein the electromagnetic energy is redirected in a second propagation direction by a rectangular waveguide.

24. The method of claim 22, wherein the electromagnetic energy is redirected in a third propagation direction by a cylindrical waveguide.
